(19) United States
(12) Patent Application Publication
(10) Pub. No.: US 2015/0300585 A1
(43) Pub. Date: Oct. 22, 2015

(54) LED LAMP

(71) Applicant: UNITY OPTO TECHNOLOGY CO., LTD., New Taipei City (TW)

(72) Inventors: Chih-Hsien Wu, New Taipei City (TW); Po-Wen Hsiao, New Taipei City (TW); Han-Chi Chi, New Taipei City (TW)

(21) Appl. No.: 14/321,943

(22) Filed: Jul. 2, 2014

(30) Foreign Application Priority Data
Apr. 18, 2014 (TW) 103206803

(51) Int. Cl. F21S 8/06; F21K 99/00

(52) U.S. Cl. CPC F21S 8/061; F21K 9/30; F21Y 2103/003

(57) ABSTRACT

An LED lamp is connected to a pair of connecting elements and includes at least one lamp tube and two end caps. One end cap includes a power supply element and is electrically connected to an LED module, and the other end cap is connected to the lamp tube and includes a power conversion element. The end cap has an electric wire and a plug connected to the power supply element through the electric wire and connected to a socket for power supply. The lamp tube has a backlight surface, a light exit surface, and first latch portions disposed at both ends of the lamp tube, and the two end caps have at least one second latch portion and a fixing portion with a first through hole each, so that the connecting elements can be fixed to the two end caps through the first through holes.

### CROSS-REFERENCE TO RELATED APPLICATIONS

This non-provisional application claims priority under 35 U.S.C. §119(a) on Patent Application No(s). 103206803 filed in Taiwan, R.O.C. on Apr. 18, 2014, the entire contents of which are hereby incorporated by reference.

### BACKGROUND OF THE INVENTION

1. Field of the Invention

The present invention relates to the technical field of illuminating lamp devices, and more particularly to an LED lamp having a plug for electrically connecting an external socket and providing a convenient way of installing or hanging the lamp.

2. Description of the Related Art

As science and technology advance, LED lamps are usually installed in indoor and outdoor environment for the illumination purpose, and there are various different lamps to meet different application requirements. In general, the common types of indoor LED lamps include lamp tubes, embedded lamps, shelf lights, etc, and these lamps are installed at the ceiling for the illumination purpose.

For example, a fixture is installed at the ceiling before a hanging lamp is installed, and then a lamp tube with an installed LED lamp is mounted onto the fixture by a rotating method, wherein an end cap is connected separately to both sides of the LED lamp tube, and a side of the two end caps coupled to the LED lamp tube has a plurality of pins, and the fixture has a plurality of electric connecting holes corresponding to the pins respectively, so that the LED lamp tube is electrically conducted after the two end caps and the fixture are connected. Obviously, the installation procedure of such lamp is complicated and time-consuming. In addition, it is necessary to mount the fixture in an indoor space and build the electric connecting holes in order to electrically conduct the pins with the electric connecting holes to supply electric power to an LED after the installation. However, there are many different pin specifications of the LED lamp tubes available in the market, so that the situations of having incompatible specifications and failing to install the fixture occur very often. In addition, the two end caps and the LED lamp tube are connected by a metal fastener, so that after a long time of use, they may be loosened or damaged easily, or even worse, the LED lamp tube may fall out. For example, the lamp tube available in the market usually comes with a lamp fixture of a fixed size, and manufacturers call such lamp tubes as T8 lamp tubes with G13 pin specification and T5 lamp tubes with G5 pin specification, and the T8 lamp tubes and the T5 lamp tubes cannot be used universally in the incompatible lamp fixtures. On the other hand, the conventional lamp may adopt electromagnetic or electronic ballasts, so that if the LED lamp tube is installed with an incompatible or incorrect specification, the LED lamp tube may be burned or damaged. Even if the circuits in the conventional LED lamp tube and its fixture are modified and tailor-made, the issue of hardware installation may occur.

Therefore, the inventor of the present invention designed an LED lamp in accordance with the present invention to overcome the drawbacks of the conventional LED lamp tube that is used for the illumination purpose.

### SUMMARY OF THE INVENTION

Therefore, it is a primary object of the present invention to provide an LED lamp that can be hung or fixed in an indoor environment by a connecting element for the purpose of illumination, and the LED lamp includes an electric wire and a plug for connecting an external socket without requiring the installation of components such as a fixture and an electric connecting element in advance indoor, and the LED lamp can supply current to the lamp through the plug after the installation and construction, so as to improve the convenience of installation and use.

Another objective of the present invention is to provide an LED lamp, wherein the lamp tube is latched to the end caps at both ends of the lamp tube to facilitate users to remove or install internal components of the lamp tube and achieve the effects of quick installation, and convenient replacement and maintenance.

To achieve the aforementioned and other objectives, the present invention provides an LED lamp coupled to a pair of connecting elements to facilitate installing or hanging the LED lamp, and the LED lamp comprises at least one lamp tube and two end caps, and the lamp tube includes an LED module installed therein, and one of the end caps is coupled to an end of the lamp tube and includes at least one power supply element and is electrically coupled to the LED module, and the other end of the end cap is coupled to the other end of the lamp tube and includes at least one power conversion element installed therein and is electrically coupled to the LED module, characterized in that the lamp tube has a backlight surface and a light exit surface, and both ends of the lamp tube have a first latch portion each, and the two end caps have at least one second latch portion corresponsive to the first latch portion and connected to one another to define a sealed condition, and a side of the two end caps has a fixing portion, and the two fixing portions have a first through hole each, and the pair of connecting elements are fixed to the two end caps through the first through holes respectively, and an electric wire and a plug are extended from one of the end caps, and the plug is electrically conducted with the power supply element through the electric wire, and the plug is coupled to a socket for supplying electric power to the lamp tube.

Wherein, the fixing portion is extended outwardly from the top side of the two end caps, and the first through hole of one of the fixing portions is tapered towards a side, and the first through hole of the other fixing portion is tapered towards both sides and provided for fixing the pair of connecting elements. The first latch portions are extended outwardly from the top side of the two end caps, and the first through hole of one of the fixing portions is tapered towards a side, and the first through hole of the other fixing portion is tapered towards both sides and provided for fixing the pair of connecting elements.

To provide diversified hanging and installing methods, at least one the fixing portion has a second through hole in a circular shape and formed on a side of the first through hole.

In addition, the backlight surface is made of a mixture of fiberglass and polycarbonate and the light exit surface is transparent and integrally formed with the backlight surface by extrusion molding, so that the lamp tube has a better rigidity to prevent it from being bent or deformed easily. The lamp tube includes a containing slot formed therein for fixing the LED module. The present invention further comprises a switch installed at the electric wire for controlling a current conduction condition.

In another preferred embodiment, there are multiple lamp tubes, and the quantity of the second latch portions is corresponsive to the quantity of the lamp tubes, and the first latch portions are a plurality of latch holes, and the second latch portions are substantially inuring shape and have a plurality of ribs disposed on an inner side of the second latch portions for latching the first latch portions respectively.

The present invention further comprises a rear cover and a switch, and the rear cover has at least one clamping element corresponding to the lamp tube for clamping the lamp tube and is installed at the backlight surface of the lamp tube, and the switch is installed at one of the end caps and electrically connected to the power supply element.

### BRIEF DESCRIPTION OF THE DRAWINGS

FIG. 1 is an exploded view of an LED lamp of a first preferred embodiment of the present invention;

FIG. 2 is a schematic view of installing an LED lamp of the first preferred embodiment of the present invention;

FIG. 3 is an exploded view of an LED lamp of the first preferred embodiment of the present invention;

FIG. 4 is an exploded view of an LED lamp of a second preferred embodiment of the present invention;

FIG. 5 is a schematic view of installing an LED lamp of the second preferred embodiment of the present invention;

FIG. 6 is a schematic view of installing an LED lamp of the second preferred embodiment of the present invention; and

FIG. 7 is a schematic view of installing an LED lamp in accordance with another implementation mode of the second preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

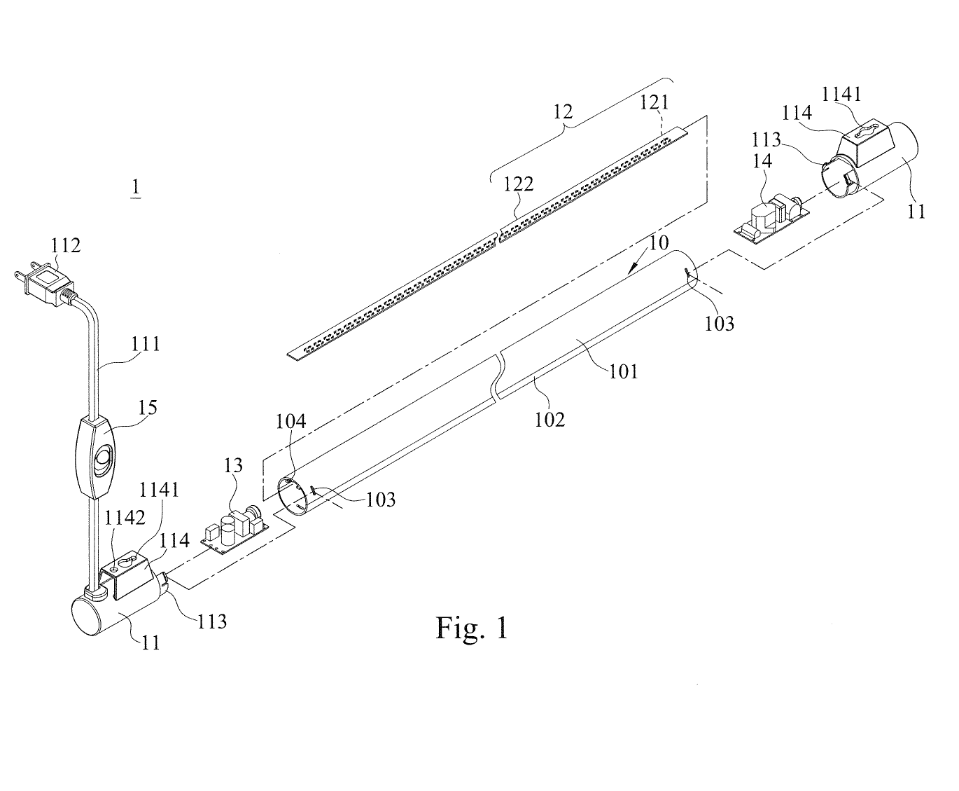

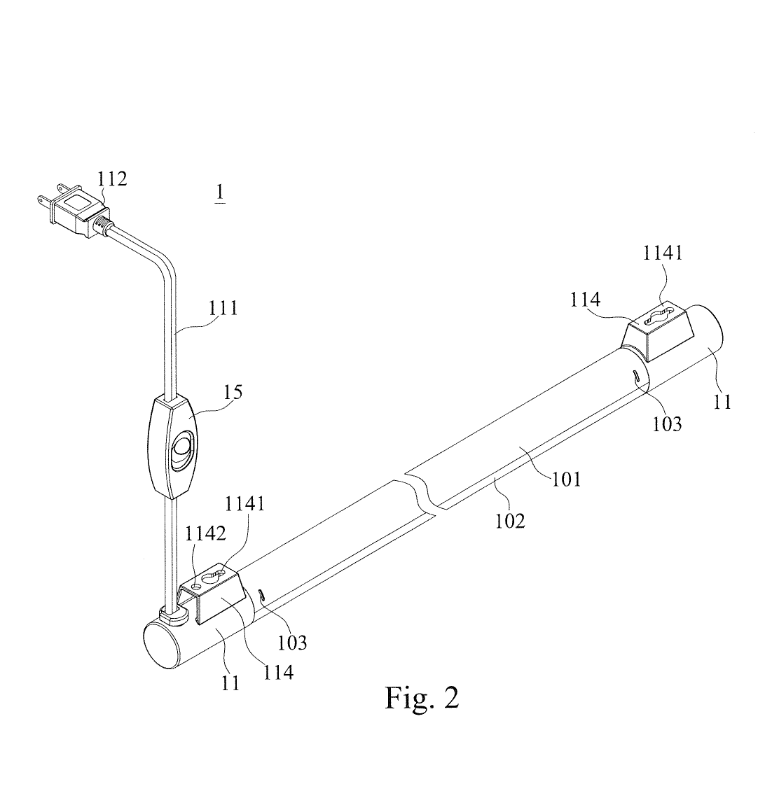

With reference to FIGS. 1 to 3 for an exploded view of an LED lamp and schematic views of installing the LED lamp in accordance with the first preferred embodiment of the present invention respectively, the LED lamp 1 is connected to a pair of connecting elements 2 to facilitate installing or hanging the LED lamp 1, and the LED lamp 1 comprises at least one lamp tube 10 and two end caps 11, and the lamp tube 10 includes an LED module 12 installed therein, and the LED module 12 includes a circuit board 122 and a plurality of LED elements 121, and the LED elements 121 are installed on the circuit board 122, and the circuit board 122 is a metal substrate printed circuit board. an that the LED lamp 1 has a good heat dissipation effect to extend the service life effectively, wherein one of the end caps 11 is connected to an end of the lamp tube 10 and includes a power supply element 13 electrically coupled to the LED module 12, and the other end of the end cap 11 is connected to the other end of the lamp tube 10 and includes a power conversion element 14 electrically coupled to the LED module 12. Wherein, the power supply element 13 can effectively prevent electromagnetic interference produced during the use of the LED lamp, and the power conversion element 14 is provided for converting the type of current of the LED lamp.

The LED lamp 1 of the present invention is characterized in that the lamp tube 10 has a backlight surface 101 and a light exit surface 102, and a first latch portion 103 disposed separately at both ends of the lamp tube 10, and the two end caps 11 have at least one second latch portion 113 corresponsive to the first latch portion 103 and connected to one another to define a sealed condition. In this preferred embodiment, the first latch portions 103 are a plurality of latch holes, and the second latch portions 113 have a plurality of ribs formed on an external side of the second latch portions 113 and latched to the first latch portions 103, so that if it is necessary to combine the two end caps 11 and the lamp tube 10, the second latch portions 113 are latched to two end openings of the lamp tube 10 to connect the first latch portions 103 respectively, and the rib and the latch hole can be fixed securely with each other to achieve the simple and easy installation and removal effect. A side of the two end caps 11 has a fixing portion 114, and the two fixing portions 114 have a first through hole 1141 each, and the pair of connecting elements 2 are fixed to the two end caps 11 through the first through holes 1141, so that the LED lamp 1 can be hung at an indoor environment. After the installation is completed, the plug 112 and the socket 3 can be connected to each other to supply electric power to the lamp tube 10, so that the LED module 12 can emit light to achieve the illumination effect, so as to save the labor and time of installing the lamp significantly. One of the end caps 11 has an electric wire 111 and a plug 112, and the plug 112 is electrically conducted with the power supply element 13 through the electric wire 111 and connected to a socket 3 for supplying electric power to the lamp tube 10, so that after the LED lamp 1 is installed in a predetermined area or space, the plug 112 is used for connecting the socket 3. The present invention further comprises a switch 15 installed at the electric wire 111 and provided for controlling the ON or OFF status of the current when a user connects the plug 112 to the socket 3 to turn on or off the LED lamp 1.

In this preferred embodiment, the fixing portions 114 is extended outwardly from the top of the two end caps 11, and the first through hole 1141 of one of the fixing portions 114 is tapered towards a side, and the Oct through hole 1141 of the other fixing portion 114 is tapered towards both sides. In FIG. 1, a side of one of the first through holes 1141 is substantially circular and the other side is substantially elliptical. The center of the other first through hole 1141 is circular, and both sides are substantially elliptical. The pair of connecting elements 2 can be slings or screws depending on the installation environment and requirements. When connecting to the Oct through holes 1141, the pair of connecting elements 2 are installed to the circular area of the first through hole 1141 and slid to the tapered side of the first through hole 1141 to form an elliptic area, so as to achieve the fixing effect and provide an easy installation or removal of the LED lamp 1.

Wherein, at least one the fixing portions 114 further includes a second through hole 1142 substantially in a circular shape and formed on a side of the first through hole 1141. In this preferred embodiment, one of the fixing portions 114 has the second through hole 1142 preferably disposed on a side facing towards the second through hole 1142 and tapered towards a side of the first through hole 1141. The pair of connecting elements 2 may be hanging hooks, wherein after an end of one of the connecting element 2 is hooked into the second through hole 1142, and an end of the other connecting element 2 is hooked into the first through hole 1141 to form a tapered side, the other end of the pair of connecting elements 2 can be connected to a position to install the LED lamp 1 to hang and fix the LED lamp 1.

In addition, the backlight surface 101 of the lamp tube 10 is made of a mixture of fiberglass and polycarbonate, and the light exit surface 102 is transparent and integrally formed with the backlight surface 101 by extrusion molding. Fiberglass and polycarbonate have the property of enhancing the rigidity of the lamp tube 10 to increase the strength of the backlight surface 101 and reduce the chance of being bent or deformed in the manufacturing process. The lamp tube 10 includes a containing slot 104 formed therein and provided for fixing the LED module 12. Preferably, the containing slot 104 is proximate to the backlight surface 101, so that after the LED module 12 is installed into the containing slot 104, the light emitting direction faces towards the light exit surface 102 to facilitate emitting light to the outside.

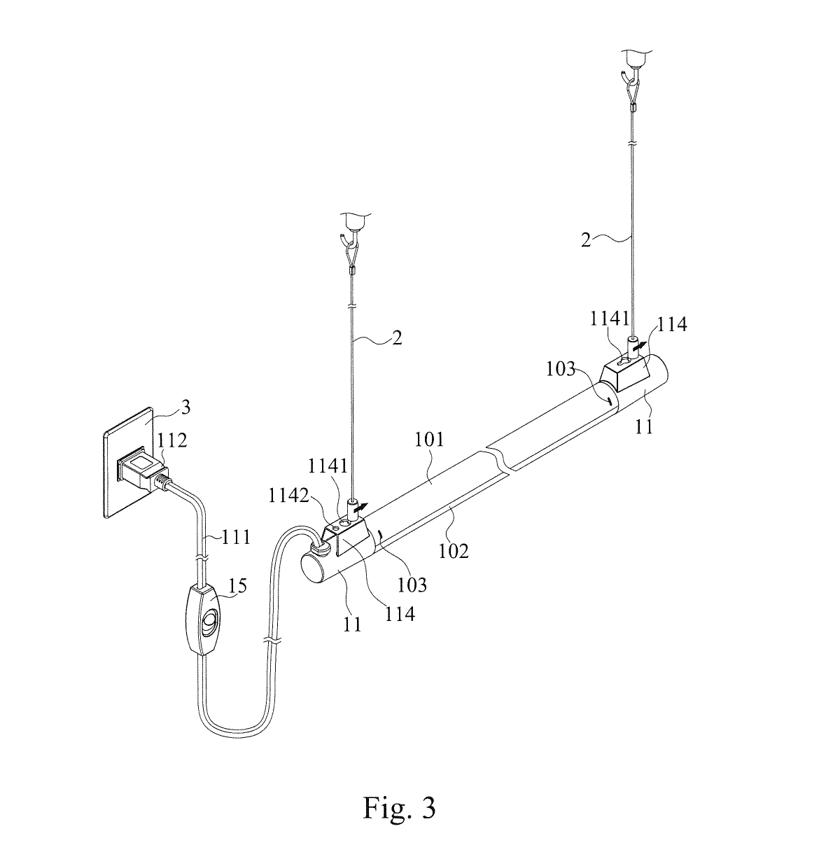

In FIG. 3, the pair of connecting elements 2 are slings, and an end of the pair of connecting elements 2 is substantially in a cylindrical shape, and latched into the circular area from the first through holes 1141, and then slid horizontally to latch the pair of connecting elements 2 to the tapered side of the first through holes 1141, and then the other end of the pair of connecting elements 2 is installed to a desired position, and the plug 112 and the socket 3 are connected to each other for supplying electric power to the lamp tube 10 to emit light, so as to achieve the effects of quick installation and convenient application. After the LED lamp 1 is installed, the plug 112 is normally connected to the socket 3, so that users can control the ON/OFF status of the LED lamp 1 by the switch 15.

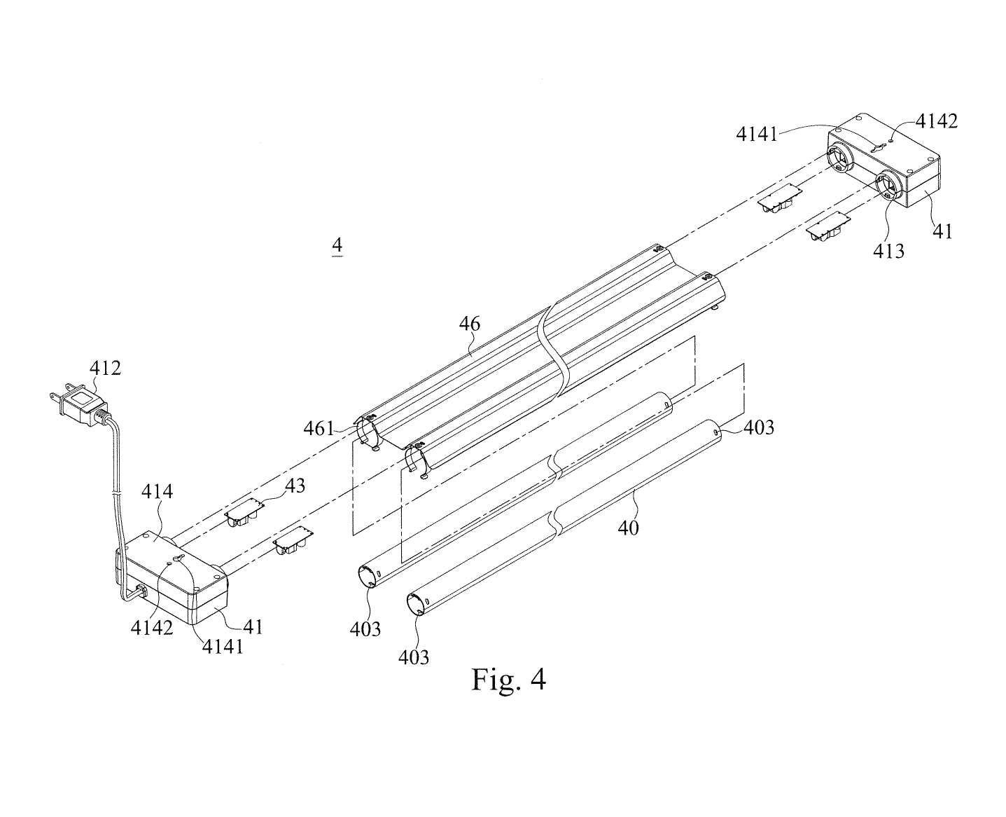

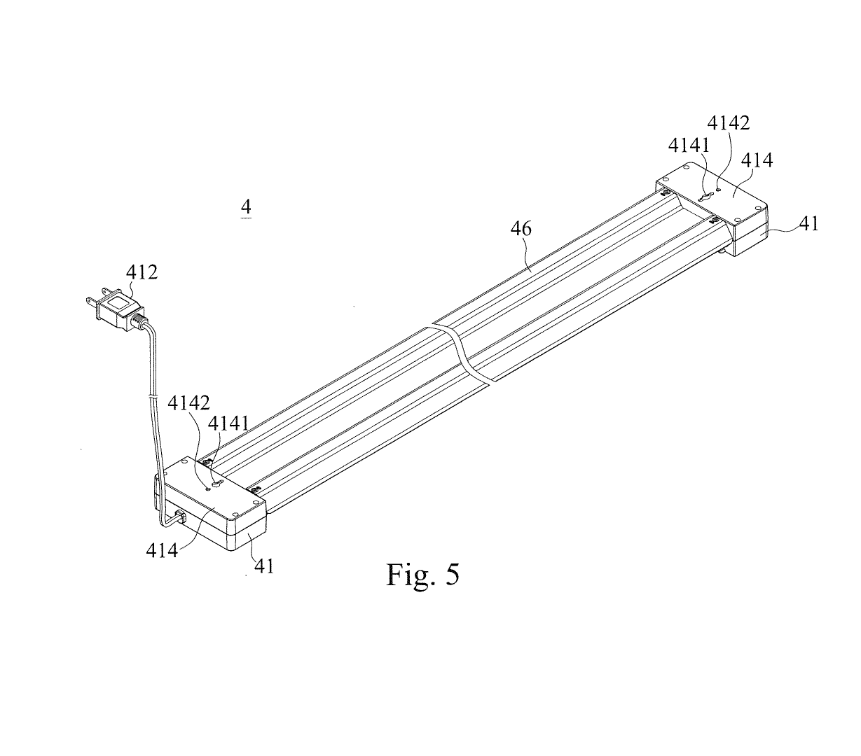

With reference to FIGS. 4, 5 and 6 for an exploded view, a perspective view, and a schematic view of installing an LED lamp of the second preferred embodiment of the present invention respectively, this embodiment is similar to the first preferred embodiment except that there are multiple lamp tubes 40 in this embodiment, and the quantity of the second latch portions 413 is corresponsive to the quantity of the lamp tubes 40. In this preferred embodiment, there are two lamp tubes 40, but the invention is not limited to this number only. The first latch portions 403 of the lamp tubes 40 are a plurality of latch holes, and the second latch portions 413 are substantially in a ring shape and having a plurality of ribs formed on an inner side of the second latch portions 413 and latched to the first latch portions 403, so that if it is necessary to combine the lamp tube 40 and the two end caps 41, the second latch portions 413 are connected to the external side of two end openings of each lamp tube 40, and the rib and the latch hole are fixed to each other. In addition, the two fixing portions 414 are disposed at the top of the two end caps 41, while the first preferred embodiment includes the first through hole 4141, and the two fixing portions 414 have the second through hole 4142 each , and the second through holes 4142 are disposed on a side of the first through holes 4141.

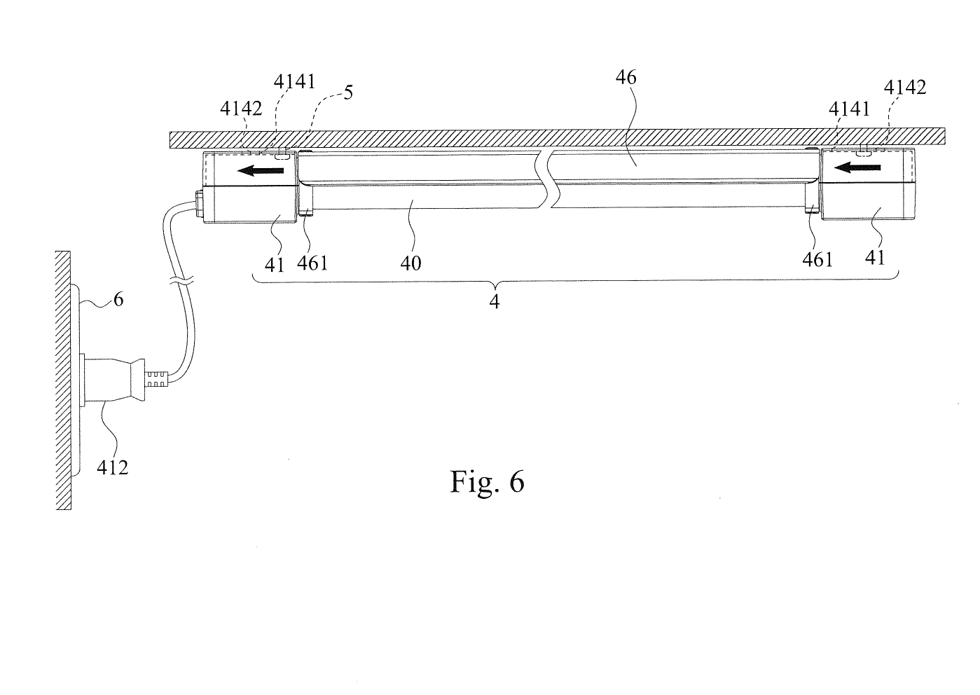

The present invention further comprises a rear cover 46 having at least one clamping element 461 corresponsive to the lamp tube 40 and installed at the backlight surface 401 of the lamp tube 40 and connected to the lamp tube 40 through the clamping element 461. Preferably, the clamping element 461 is clamped onto the external side of two end openings of the lamp tube 40. In this preferred embodiment, there are two lamp tubes 40, so that the quantity of clamping element 461 is equal to four, and paired and configured to be corresponsive to the first latch portions 403 of the two lamp tubes 40. When the second latch portions 413 and the first latch portions 403 of this preferred embodiment are connected, the second latch portions 413 are disposed on the external sides of the two end openings of each lamp tube 40, so that when the rear cover 46 and the lamp tubes 40 are assembled, the clamping elements 461 are clamped onto the external sides of the second latch portions 413 respectively. In FIG. 6, the pair of connecting elements 5 are screws and fixed to a desired installation position in advance, and the pair of connecting elements 5 are placed at the center of the first through holes 4141 and slid horizontally when installing the LED lamp 4, and the pair of connecting elements 5 are latched to the tapered position of the first through holes 4141 in order to hang and fix the LED lamp 4.

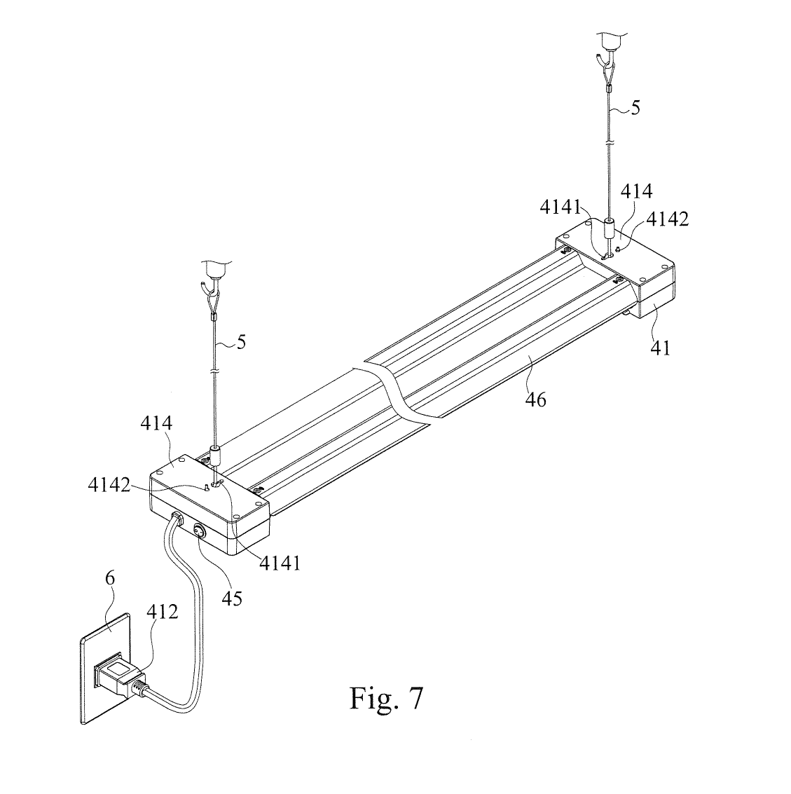

With reference to FIG. 7 for a schematic view of installing an LED lamp in accordance with another implementation mode of the second preferred embodiment of the present invention, the LED lamp 4 of this embodiment comprises a switch 45 for controlling the ON/OFF status of the LED lamp 4, and the switch 45 is installed at one of the end caps 41 and electrically connected to the power supply element 43, so that after the LED lamp 4 is installed and the plug 412 is connected to the socket 6, a user may control the illumination status of the LED lamp 4 by the switch 45. Preferably, the switch 45 is a two-stage DIP switch. In addition, the LED lamp 4 may include a wireless control switch or a passive infrared (PIR) sensor for controlling the ON/OFF status of the LED lamp 4 by different sensing methods or trigger conditions. In this implementation mode, the first through holes 4141 are tapered towards an end, and disposed opposite to each other as shown in FIG. 7. In addition, the pair of connecting elements 5 are hanging hooks provided for hooking into the first through holes 4141 and the second through holes 4142 to achieve the hanging and fixing effects.

What is claimed is:

1. An LED lamp, coupled to a pair of connecting elements to facilitate installing or hanging the LED lamp, and comprising at least one lamp tube and two end caps, and the lamp tube including an LED module installed therein, and one of the end caps being coupled to an end of the lamp tube and including at least one power supply element and being electrically coupled to the LED module, and an another end of the end cap being coupled to the other end of the lamp tube and including at least one power conversion element installed therein and being electrically coupled to the LED module, characterized in that the lamp tube has a backlight surface and a light exit surface, and both ends of the lamp tube have a first latch portion respectively, and the two end caps have at least one second latch portion corresponsive to the first latch portion and connected to one another to define a sealed condition, and a side of the two end caps has a fixing portion, and the two fixing portions have a first through hole each, and the pair of connecting elements are fixed to the two end caps through the first through holes respectively, and an electric wire and a plug are extended from one of the end caps, and the plug is electrically conducted with the power supply element through the electric wire, and the plug is coupled to a socket for supplying electric power to the lamp tube.

2. The LED lamp of claim 1, wherein the fixing portion is extended outwardly from the top side of the two end caps, and the first through hole of one of the fixing portions is tapered towards a side, and the first through hole of the other fixing portion is tapered towards both sides and provided for fixing the pair of connecting elements.

3. The LED lamp of claim 2, wherein the first latch portions are a plurality of latch holes, and the second latch portions have a plurality of ribs latched to the first latch portions respectively.

4. The LED lamp of claim 2, wherein the first latch portions are a plurality of latch holes, and the second latch portions are substantially in a ring shape and have a plurality of ribs disposed on an inner side of the second latch portions for latching the first latch portions respectively.

5. The LED lamp of claim 3, wherein at least one the fixing portion has a second through hole in a circular shape and formed on a side of the first through hole.

6. The LED lamp of claim 5, wherein the lamp tube comes with a plural quantity, and the second latch portions are configured corresponsive to the quantity of the lamp tubes.

7. The LED lamp of claim 6, further comprising a rear cover, and the rear cover having at least one clamping element corresponding to the lamp tube for clamping the lamp tube, and being installed at the backlight surface of the lamp tube.

8. The LED lamp of claim 6, further comprising a rear cover, and the rear cover having at least one clamping element corresponding to the lamp tube for clamping the lamp tube, and when the second latch portions and the first latch portions are connected, the clamping elements are clamped onto the external sides of the second latch portions respectively.

9. The LED lamp of claim 4, wherein at least one the fixing portion has a second through hole in a circular shape and formed on a side of the first through hole.

10. The LED lamp of claim 9, wherein the lamp tube comes with a plural quantity, and the second latch portions are configured corresponsive to the quantity of the lamp tubes.

11. The LED lamp of claim 10, further comprising a rear cover, and the rear cover having at least one clamping element corresponding to the lamp tube for clamping the lamp tube, and being installed at the backlight surface of the lamp tube.

12. The LED lamp of claim 1, wherein the backlight surface is made of a mixture of fiberglass and polycarbonate, and the light exit surface is transparent and integrally formed with the backlight surface by extrusion molding.

13. The LED lamp of claim 1, wherein the lamp tube includes a containing slot formed therein for fixing the LED module.

14. The LED lamp of claim 1, further comprising a switch installed at the electric wire for controlling a current conduction condition.

15. The LED lamp of claim 1 further comprising a switch installed at one of the end caps and electrically coupled to the power supply element.
